(19) United States
(12) Patent Application Publication
(10) Pub. No.: US 2019/0393798 A1
(43) Pub. Date: Dec. 26, 2019

(54) BUCK-BOOST POWER CONVERSION SYSTEM

(71) Applicant: NORTH CAROLINA STATE UNIVERSITY, Raleigh, NC (US)

(72) Inventors: WENSONG YU, Raleigh, NC (US); Alex Qin Huang, Raleigh, NC (US)

(21) Appl. No.: 16/465,358

(22) PCT Filed: Dec. 8, 2017
(86) PCT No.: PCT/US2017/065409

§ 371 Date: May 30, 2019

Related U.S. Application Data
(60) Provisional application No. 62/432,344, filed on Dec. 9, 2016.

(51) Int. Cl. H02M 5/293; H02M 7/5387; H02J 3/38; H02J 7/02

(52) U.S. Cl. CPC H02M 5/293; H02J 7/022; H02J 3/383; H02M 7/5387

(57) ABSTRACT

A buck-boost power conversion system for converting between direct current (“DC”) voltages and alternating current (“AC”) voltages of different magnitudes can include a DC/AC switched network and an AC/AC switched network for converting a DC voltage to an AC voltage of a different magnitude with a minimized number of inductors and without using a transformer. The buck-boost power conversion system can be bidirectional such that a DC voltage can be converted to an AC voltage and an AC voltage can be converted to a DC voltage. A DC voltage can be input to the buck-boost power conversion system and an AC voltage can be output with a greater or lesser magnitude than the DC voltage. In additional or alternative examples, an AC voltage can be input to the buck-boost power conversion system and a DC voltage can be output with a lesser or greater magnitude than the AC voltage.

### CROSS-REFERENCE TO RELATED APPLICATIONS

This disclosure claims priority to U.S. Provisional Application No. 62/432,344, titled “Buck-Boost Power Conversion System,” filed Dec. 9, 2016, the entirety of which is hereby incorporated by reference herein.

### GOVERNMENT LICENSE RIGHTS

This invention was made with government support under grant number DE-EE0006036 awarded by the U.S. Department of Energy. The government has certain rights in this invention.

### TECHNICAL FIELD

The present disclosure relates generally to power conversion systems and more particularly (although not necessarily exclusively), to a buck-boost power conversion system.

### BACKGROUND

A voltage source inverter can be used to interface a direct current (“DC”) source with an alternating current (“AC”) load. In some instances, the voltage source inverter may be used to convert between AC voltage and DC voltage, but the voltage source inverter may inefficiently convert from one voltage to another (e.g., the voltage source inverter may produce an AC output voltage that is lower than a DC input voltage).

### SUMMARY

In one example, a system of the present disclosure includes a buck-boost power conversion circuit for converting between a DC voltage having a first magnitude and a first AC voltage having a second magnitude. The buck-boost power conversion circuit includes a DC/AC switched network configured to be electrically coupled to the DC voltage for converting between the DC voltage and a second AC voltage. The buck-boost power conversion circuit also includes an AC/AC switched network configured to be electrically coupled to the DC/AC switched network for converting between the first AC voltage and the second AC voltage.

In another example, a method of the present disclosure includes receiving, by a buck-boost power conversion circuit, a DC voltage from a DC source electrically coupled to the buck-boost power conversion circuit. The method can further include converting, by the buck-boost power conversion circuit, the DC voltage to a second AC voltage using a DC/AC switched network. The method can further include converting, by the buck-boost power conversion circuit, the second AC voltage to a first AC voltage using an AC/AC switched network. The method can further include outputting, by the buck-boost power conversion circuit, the first AC voltage to an AC load electrically coupled to the buck-boost power conversion circuit. The first AC voltage can have a different magnitude than the DC voltage.

In another example, a method of the present disclosure includes receiving, by a buck-boost power conversion circuit, a first AC voltage from an AC source electrically coupled to the buck-boost power conversion circuit. The method can further include converting, by the buck-boost power conversion circuit, the first AC voltage to a second AC voltage using an AC/AC switched network. The method can further include converting, by the buck-boost power conversion circuit, the second AC voltage to a DC voltage using a DC/AC switched network. The method can further include outputting, by the buck-boost power conversion circuit, the DC voltage to a DC load electrically coupled to the buck-boost power conversion circuit, the DC voltage having a different magnitude than the first AC voltage.

### BRIEF DESCRIPTION OF THE DRAWINGS

FIG. 1 is a block diagram of a buck-boost power conversion circuit in which alternating current (“AC”) voltage of an AC load or an AC source can be higher or lower than a direct current (“DC”) voltage of a DC source or a DC load according to some aspects.

FIG. 2 is a block diagram of a buck-boost power conversion circuit according to some aspects.

FIG. 3 is a schematic diagram of a buck-boost power conversion circuit with multiple DC nodes according to some aspects.

FIG. 4 is a schematic diagram of the buck-boost power conversion circuit of FIG. 3 according to some aspects.

FIG. 5 is a schematic diagram of the buck-boost power conversion circuit of FIG. 3 according to some aspects.

FIG. 6 is a block diagram of a buck-boost power conversion system according to some aspects.

### DETAILED DESCRIPTION

Certain aspects and features relate to a buck-boost power conversion system for converting between direct current (“DC”) voltages and alternating current (“AC”) voltages of different magnitudes. As used herein, the term “buck-boost power conversion system” is used to refer to any system that includes a buck-boost power conversion circuit. In some examples, a buck-boost power conversion system can include a buck-boost power conversion circuit and one or more additional components or elements. As used herein, the term “buck-boost power conversion circuit” is used to refer to a circuit that includes a DC/AC switched network and an AC/AC switched network for converting a DC voltage to an AC voltage of a different magnitude. A buck-boost power conversion system according to one example can include a DC/AC switched network and an AC/AC switched network for converting a DC voltage to an AC voltage of a different magnitude with a minimized number of inductors and without using a transformer. The DC/AC switched network can convert between a DC voltage and an AC voltage. In some examples, the DC voltage can include various DC voltages and the DC/AC switched network can include various DC/AC switched networks electrically coupled in series for converting between the various DC voltages and one or more AC voltages. The AC/AC switched network can be electrically coupled to the DC/AC switched network and convert between the AC voltage and another AC voltage of a different magnitude. A buck-boost power conversion system of the present disclosure can be bidirectional such that a DC voltage can be converted to an AC voltage and an AC voltage can be converted to a DC voltage. In some examples, a DC voltage can be input to the buck-boost power conversion system and an AC voltage can be output with a greater or lesser magnitude than the DC voltage. In additional or alternative examples, an AC voltage can be input to the buck-boost power conversion system and a DC voltage can be output with a lesser or greater magnitude than the AC voltage.

In some aspects, the buck-boost power conversion system can interface between an AC source or an AC load (e.g., an electrical grid) and one or more DC sources or DC loads (e.g., photovoltaics or batteries). For example, a photovoltaic cell can generate a DC voltage that is less than the AC voltage used by an electrical grid. The buck-boost power conversion system can electrically couple the photovoltaic cell to the electrical grid by converting the DC voltage to an AC voltage of equal magnitude as the magnitude of the AC voltage being used on the electrical grid.

In some aspects, a buck-boost power conversion system can be bidirectional. A bidirectional power conversion system can convert a DC voltage to an AC voltage and an AC voltage to a DC voltage. For example, a buck-boost power conversion system can electrically couple one or more batteries to an electrical grid. In some examples, the buck-boost power conversion system can convert AC voltage from the electrical grid to DC voltage electrically coupled to a battery for charging the battery. In some instances, a magnitude of the DC voltage can be greater or lesser than a magnitude of the AC voltage. Each of the batteries can be electrically coupled to a DC/AC switched network and each DC/AC switched network can be electrically coupled in series to an AC/AC switched network to allow the batteries to charge and discharge independently. As the batteries charge, AC voltage from the electrical grid can be converted to DC voltages outputted to the charging batteries. As the batteries discharge, DC voltage from the batteries can be converted to an AC voltage used by the electrical grid.

In some aspects, existing systems can use a voltage source inverter to interface a DC source (e.g., a photovoltaic or battery) with an AC load (e.g., an electrical grid). In some examples, the voltage source inverter may be a buck-type inverter, which can produce an AC output voltage that is lower than a DC input voltage. To maintain an AC output voltage equal to the AC voltage of the grid, a minimum DC input voltage to the buck-type inverter may be greater than a peak AC voltage of the grid. The minimum DC input voltage may eliminate the use of some DC sources or the DC sources may be electrically coupled in series to generate the minimum DC input voltage. In additional or alternative aspects, existing systems can use a boost-type inverter, which can place a limit on the number of DC sources that may be electrically coupled together. A buck-boost power conversion system according to some examples of the present disclosure can include a buck-boost type inverter that can allow any number of DC sources to be electrically coupled together to generate the DC input voltage.

In some aspects, a buck-boost power conversion system can be a bidirectional converter system with high efficiency, flexibility, redundancy, and low cost that allows any number of DC sources or DC loads to be coupled to an electrical grid. For example, an electrical grid operating at 240 V AC may have a peak voltage of 400 V. A solar panel may generate 25 V DC. Existing systems may use sixteen or more panels to ensure that the DC voltage input is greater than the peak AC voltage of the electrical grid. A buck-boost power conversion system according to some examples of the present disclosure can allow any DC voltage input to be coupled to the system by converting the DC voltage to the AC voltage being used by the electrical gird. In some aspects, the system can be robust and reduce operating costs by reducing the use of additional hardware for protecting an electrical grid. For example, the AC/AC switched network can include a semiconductor that can perform anti-islanding operations, which deactivate the system in response to a power outage on the electrical grid. In additional or alternative aspects, the system can be smaller, lighter, and cheaper than existing power conversion systems by using a single inductor to electrically couple the AC/AC switched network and the DC/AC switched network and avoid employing transformers. In additional or alternative aspects, the system can be safer than existing power conversion systems by combining a low DC voltage with a relatively high AC voltage, which can generate zero voltage for all DC terminals in every half AC period and prevent DC arcs that can occur at DC voltages.

The illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

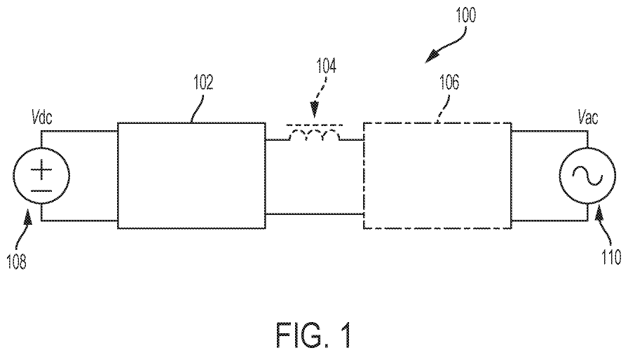

FIG. 1 is a block diagram of a buck-boost power conversion circuit 100 in which alternating current (“AC”) voltage of an AC source or an AC load 110 (e.g., an electrical grid) can be higher or lower than a direct current (“DC”) voltage of a DC source or DC load 108 according to some aspects.

The buck-boost power conversion circuit 100 can include a DC/AC switched network 102 electrically coupled by only one inductor 104 to an AC/AC switched network 106. The DC/AC switched network 102 can be electrically coupled to a DC voltage used by a DC source or a DC load 108 (e.g., a battery) for converting between the DC voltage and an AC voltage. The AC voltage can be shared with the AC/AC switched network 106 that can convert between the AC voltage and another AC voltage of a different magnitude used by an AC source or an AC load 110 (e.g., an electrical grid). For example, the DC load 108 can provide the DC voltage to the DC/AC switched network 102. The DC/AC switched network 102 can be configured to function as a buck converter circuit, wherein a second AC voltage output by the DC/AC switched network 102 is stepped down from the DC voltage input into the DC/AC network switch 102. Further to this example, the second AC voltage output by the DC/AC switched network 102 is buffered by the inductor 104 and input into the AC/AC switched network 106. The AC/AC switched network 106 can be configured to function as a boost converter circuit, wherein the first AC voltage output by the AC/AC switched network 106 is stepped up from the second AC voltage input into the AC/AC switched network 106. While in this example, the DC/AC switched network 102 can be configured to function as a buck converter circuit and the AC/AC switched network 106 can be configured to function as a boost converter circuit, the present disclosure is not limited to such configurations. Rather, in other examples, the DC/AC switched network 102 and the AC/AC switched network 106 can each be configured to function as a boost converter circuit or a buck converter circuit. Also, while in the example described above, the buck-boost power conversion circuit 100 can convert a DC voltage into an AC voltage, the present disclosure is not limited to such configurations. Rather, in other examples, a buck-boost power conversion circuit or system of the present disclosure can be bidirectional such that a DC voltage can be converted to an AC voltage or an AC voltage can be converted to a DC voltage. In some examples, a DC voltage can be input to the buck-boost power conversion system and an AC voltage can be output with a greater or lesser magnitude than the DC voltage. In additional or alternative examples, an AC voltage can be input to the buck-boost power conversion system and a DC voltage can be output with a lesser or greater magnitude than the AC voltage.

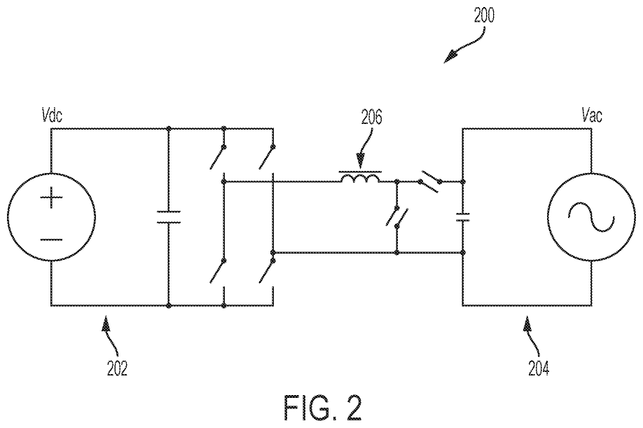

FIG. 2 is a block diagram of a buck-boost power conversion circuit 200 according to some aspects. In this example, the buck-boost power conversion circuit 200 includes a DC/AC switched network 202 that can be electrically coupled to an AC/AC switched network 204.

In some examples, the DC/AC switched network 202 can include a two-level, three-level, or other type of DC/AC voltage inverter. The AC/AC switched network 204 can include an AC/AC converter such as a semiconductor and the AC/AC switched network 204 can be electrically coupled to the DC/AC switched network 202 by a single inductor 206.

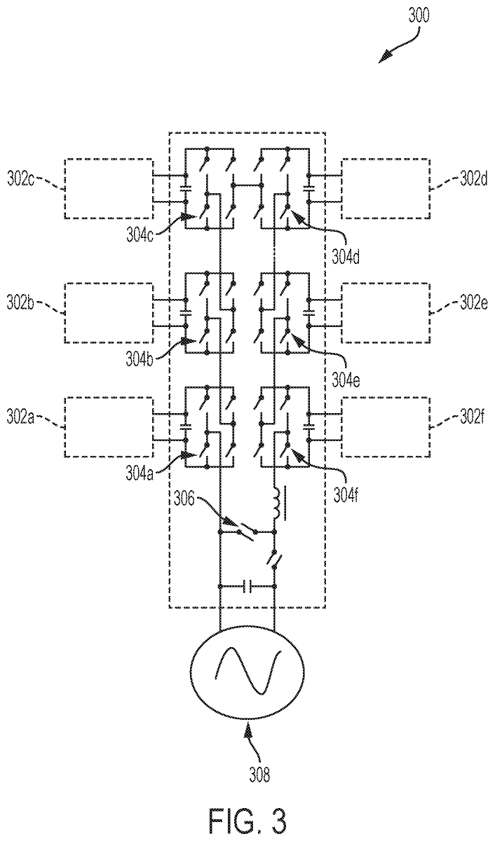

FIG. 3 is a schematic diagram of a buck-boost power conversion circuit (e.g., system) 300 with multiple DC nodes (e.g., inverters) 302a-f according to some aspects.

In some aspects, the DC nodes 302a-f can include low voltage DC sources that can each be electrically coupled to a low voltage H-bridge DC/AC inverter or a low voltage MOSFET 304a-f. In additional or alternative aspects, the DC nodes 302a-f can include DC loads (e.g., batteries). The H-bridge DC/AC inverters or low voltage MOSFETs 304a-f can be electrically coupled in series and an AC/AC voltage inverter 306 (e.g., an AC chopper) can be used to interface between the H-bridge DC/AC inverters or low voltage MOSFETs 304a-f and an AC load or AC source 308 (e.g., an electrical grid). The total DC voltage of the DC nodes 302a-f can be higher or lower than the AC voltage output by the AC/AC voltage inverter 306 allowing any number of DC nodes 302a-f and H-bridge DC/AC inverters or low voltage MOSFETs 304a-f to be electrically coupled in series.

In some examples, each of the DC nodes 302a-f can be a photovoltaic panel that can generate a maximum voltage (e.g., a maximum DC voltage based on a capability or configuration of the photovoltaic panel). The buck-boost power conversion circuit 300 can remain operational in response to the DC voltage produced by the photovoltaic panels dropping (e.g., due to cloud cover) below the AC voltage used by the AC load or AC source 308 (e.g., an electrical grid). In some examples, any number of photovoltaic panels in a photovoltaic string can be used with the buck-boost power conversion circuit 300, which can allow complete scalability for a cascaded inverter to be achieved. In additional or alternative examples, the DC nodes 302a-f can be batteries and each battery can be independently charged or discharged through an H-bridge DC/AC inverter or low voltage MOSFETs 304a-f coupled to each battery.

In some examples, the buck-boost power conversion circuit 300 can convert DC voltage generated by a photovoltaic cell to an AC voltage that is electrically coupled to an AC source or load (e.g., an electrical grid).

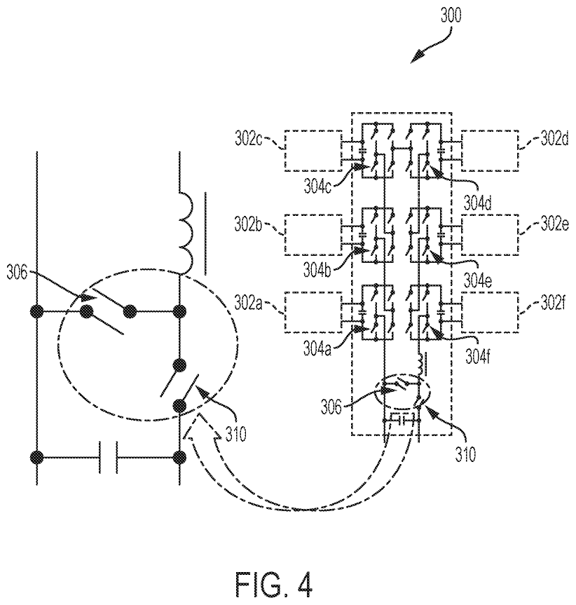

In some aspects, the AC/AC voltage inverter 306 can be a semiconductor that can block and control a voltage that passes therethrough. In some examples, the semiconductor can provide robust AC grid protection including anti-islanding. The semiconductor can provide an additional layer of redundancy to an H-bridge DC/AC inverter or low voltage MOSFETs 304a-f between an AC source or AC load (e.g., an electrical grid) and a DC node 302a-f. In additional or alternative examples, a soft-start is fully controllable from the DC-side and the AC-side. In some examples, a soft-start can include a gradual input of DC voltage or AC voltage into the buck-boost power conversion circuit 300 or a gradual increase of DC voltage or AC voltage input into the buck-boost power conversion circuit 300. A semiconductor can provide fast and reliable AC load (e.g., electrical grid) connection. In some examples, the AC/AC voltage inverter 306 can include a wide bandgap bidirectional semiconductor 310, as depicted in FIG. 4. In some examples, the wide bandgap bidirectional semiconductor 310 can execute an anti-islanding function by deactivating the buck-boost power conversion circuit 300 in response to detecting a power outage.

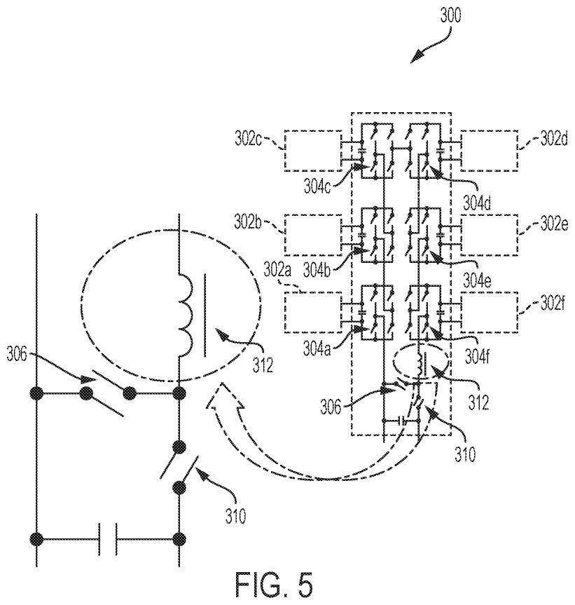

In some aspects, a single inductor 312 is used to electrically couple the AC/AC inverter 306 and the one or more DC nodes 302a-f, as depicted in FIG. 5.

In some examples, a buck-boost power conversion system of the present disclosure may not use a transformer, which can reduce the size, the weight, and the cost of the buck-boost power conversion system as compared to existing power systems.

In some aspects, a buck-boost power conversion system of the present disclosure can provide improved safety as compared to conventional systems by reducing the use of high DC voltages as inputs to the DC/AC inverter. High DC voltages can increase the risk of arcing, wherein arcing may start fires and/or cause electrical damage. In some examples, a buck-boost power conversion system of the present disclosure has no DC voltage input minimum and can limit the distribution of DC wiring to the vicinity of the DC node.

In some aspects, a buck-boost power conversion system of the present disclosure can provide improved efficiency as compared to conventional systems by minimizing conduction loss and reducing the use of high voltage diode freewheeling. In some examples, synchronous rectification can significantly reduce the conduction loss. In additional or alternative examples, interleaving techniques can dramatically reduce current ripple. In some aspects, only one power stage operates at a high frequency, as high frequency may not be needed for switching of AC switches when in Buck mode or switching of H-bridge switches when in Boost mode.

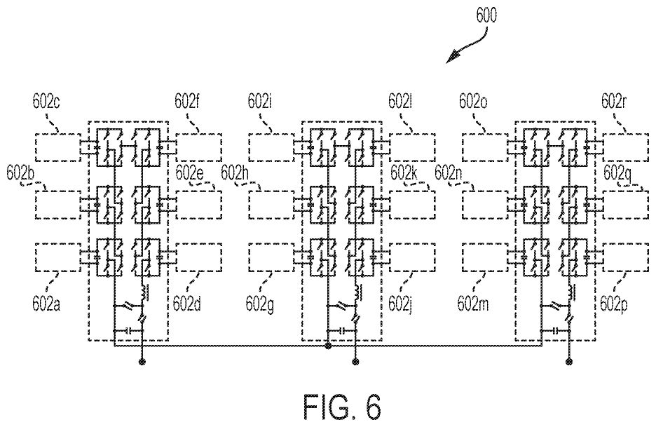

FIG. 6 is a block diagram of a buck-boost power conversion system 600 according to some aspects. In this example, the buck-boost power conversion system 600 can include various DC nodes 602a-r, which can be configured in substantially the same manner as the DC nodes 302a-f of FIG. 3, although they need not be.

In some aspects, a buck-boost power conversion circuit of the present disclosure can be coupled to interface with three-phase power. In some instances, the buck-boost power conversion circuit of the present disclosure can include various buck-boost conversion circuits and an AC voltage of each of the buck-boost power conversion circuits can be electrically coupled to interface with three-phase power.

In some aspects, a buck-boost power conversion system is provided according to one or more of the following examples:

Example #1: A system can include a buck-boost power conversion circuit for converting between a DC voltage having a first magnitude and a first AC voltage having a second magnitude. The buck-boost power conversion circuit includes a DC/AC switched network configured to be electrically coupled to the DC voltage for converting between the DC voltage and a second AC voltage and an AC/AC switched network configured to be electrically coupled to the DC/AC switched network for converting between the first AC voltage and the second AC voltage.

Example #2: The system of Example #1 may feature the buck-boost power conversion circuit being configured to convert the DC voltage configured to be generated by a photovoltaic cell to the first AC voltage that is configured to be electrically coupled to an electrical grid. The second magnitude of the first AC voltage can be greater than first magnitude of the DC voltage.

Example #3: The system of any of Examples #1-2 may feature the DC voltage including a plurality of DC voltages and the DC/AC switched network including a plurality of DC/AC switched networks configured to be electrically coupled in series for converting between the plurality of DC voltages and the second AC voltage.

Example #4: The system of any of Examples #1-3 may feature the buck-boost power conversion circuit being configured to convert the first AC voltage from an electrical grid to the DC voltage configured to be electrically coupled to a battery for charging the battery. The first magnitude of the DC voltage can be greater than the second magnitude of the AC voltage.

Example #5: The system of any of Examples #1-4 may feature the DC voltage including a plurality of DC voltages each configured to be electrically coupled to a separate battery. The DC/AC switched network can include a plurality of DC/AC switched networks configured to be electrically coupled in series for allowing the separate batteries to charge independently.

Example #6: The system of any of Examples #1-5 may feature the buck-boost power conversion circuit including a plurality of buck-boost power conversion circuits and the first AC voltage of each of the buck-boost power conversion circuits of the plurality of the buck-boost power conversion circuits can be electrically coupled to interface with three-phase power.

Example #7: The system of any of Examples #1-6 may feature the buck-boost power conversion circuit including an inductor configured to be electrically coupled between the DC/AC switched network and the AC/AC switched network.

Example #8: The system of any of Examples #1-7 may feature the AC/AC switched network including a wide bandgap bidirectional semiconductor for executing an anti-islanding function by deactivating the buck-boost power conversion circuit in response to detecting a power outage.

Example #9: A method can include receiving, by a buck-boost power conversion circuit, a DC voltage from a DC source electrically coupled to the buck-boost power conversion circuit. The method can also include converting, by the buck-boost power conversion circuit, the DC voltage to a second AC voltage using a DC/AC switched network. The method can also include converting, by the buck-boost power conversion circuit, the second AC voltage to a first AC voltage using an AC/AC switched network. The method can also include outputting, by the buck-boost power conversion circuit, the first AC voltage to an AC load electrically coupled to the buck-boost power conversion circuit, the first AC voltage having a different magnitude than the DC voltage.

Example #10: The method of Example #9 may feature the DC voltage including a plurality of DC voltages and the buck-boost power conversion circuit including a plurality of DC/AC switched networks electrically coupled in series for converting between the plurality of DC voltages and the second AC voltage.

Example #11: The method of any of Examples #9-10 may feature the DC voltage including a plurality of DC voltages, wherein receiving the plurality of DC voltages includes receiving the plurality of DC voltages from a plurality of photovoltaic cells and wherein converting the plurality of DC voltages to the second AC voltage includes using a plurality of DC/AC switched networks electrically coupled in series.

Example #12: The method of any of Examples #9-11 may feature converting, by the buck-boost power conversion circuit, the DC voltage generated by a photovoltaic cell to the first AC voltage that is electrically coupled to an electrical grid and wherein a first magnitude of the DC voltage is greater than a second magnitude of the first AC voltage.

Example #13: The method of any of Examples #9-12 may feature the buck-boost power conversion circuit including an inductor that electrically couples the DC/AC switched network and the AC/AC switched network.

Example #14: The method of any of Examples #9-13 may feature the AC/AC switched network including a wide bandgap bidirectional semiconductor for executing an anti-islanding function by deactivating the buck-boost power conversion circuit in response to detecting power outage.

Example #15: The method of any of Examples #9-14 may feature the DC voltage including a plurality of DC voltages each electrically coupled to a separate battery, wherein the DC/AC switched network includes a plurality of DC/AC switched networks electrically coupled in series for allowing the separate batteries to charge independently.

Example #16: A method can include receiving, by a buck-boost power conversion circuit, a first AC voltage from an AC source electrically coupled to the buck-boost power conversion circuit. The method can also include converting, by the buck-boost power conversion circuit, the first AC voltage to a second AC voltage using an AC/AC switched network. The method can also include converting, by the buck-boost power conversion circuit, the second AC voltage to a DC voltage using a DC/AC switched network. The method can also include outputting, by the buck-boost power conversion circuit, the DC voltage to a DC load electrically coupled to the buck-boost power conversion circuit, the DC voltage having a different magnitude than the first AC voltage.

Example #17: The method of Example #16 may feature the DC voltage including a plurality of DC voltages. The method can also include converting the second AC voltage to the DC voltage by converting the second AC voltage to the plurality of DC voltages using a plurality of DC/AC switched networks electrically coupled in series. The method can also include transmitting the plurality of DC voltages by transmitting each of the plurality of DC voltages to a separate battery for charging the separate batteries independently.

Example #18: The method of any of Examples #16-17 may feature the buck-boost power conversion circuit including an inductor that electrically couples the DC/AC switched network and the AC/AC switched network.

Example #19: The method of any of Examples #16-18 may feature the AC/AC switched network including a wide bandgap bidirectional semiconductor for executing an anti-islanding function by deactivating the buck-boost power conversion circuit in response to detecting power outage.

Example #20: The method of any of Examples #16-19 may feature the buck-boost power conversion circuit being configured to convert the second AC voltage from an electrical grid to the DC voltage electrically coupled to a battery for charging the battery.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a buck-boost power conversion circuit for converting between a DC voltage having a first magnitude and a first AC voltage having a second magnitude, the buck-boost power conversion circuit comprising:
a DC/AC switched network configured to be electrically coupled to the DC voltage for converting between the DC voltage and a second AC voltage; and
an AC/AC switched network configured to be electrically coupled to the DC/AC switched network for converting between the first AC voltage and the second AC voltage.

2. The system of claim 1, wherein the buck-boost power conversion circuit is for converting the DC voltage configured to be generated by a photovoltaic cell to the first AC voltage that is configured to be electrically coupled to an electrical grid, the second magnitude being greater than first magnitude.

3. The system of claim 1, wherein the DC voltage comprises a plurality of DC voltages and the DC/AC switched network comprises a plurality of DC/AC switched networks configured to be electrically coupled in series for converting between the plurality of DC voltages and the second AC voltage.

4. The system of claim 1, wherein the buck-boost power conversion circuit is for converting the first AC voltage from an electrical grid to the DC voltage configured to be electrically coupled to a battery for charging the battery, the first magnitude being greater than the second magnitude.

5. The system of claim 4, wherein the DC voltage comprises a plurality of DC voltages each configured to be electrically coupled to a separate battery, wherein the DC/AC switched network comprises a plurality of DC/AC switched networks configured to be electrically coupled in series for allowing the separate batteries to charge independently.

6. The system of claim 1, wherein the buck-boost power conversion circuit comprises a plurality of buck-boost power conversion circuits and wherein the first AC voltage of each of the buck-boost power conversion circuits of the plurality of the buck-boost power conversion circuits are electrically coupled to interface with three-phase power.

7. The system of claim 1, wherein the buck-boost power conversion circuit further comprises an inductor configured to be electrically coupled between the DC/AC switched network and the AC/AC switched network.

8. The system of claim 1, wherein the AC/AC switched network comprises a wide bandgap bidirectional semiconductor for executing an anti-islanding function by deactivating the buck-boost power conversion circuit in response to detecting a power outage.

9. A method comprising:
receiving, by a buck-boost power conversion circuit, a DC voltage from a DC source electrically coupled to the buck-boost power conversion circuit;
converting, by the buck-boost power conversion circuit, the DC voltage to a second AC voltage using a DC/AC switched network;
converting, by the buck-boost power conversion circuit, the second AC voltage to a first AC voltage using an AC/AC switched network; and
outputting, by the buck-boost power conversion circuit, the first AC voltage to an AC load electrically coupled to the buck-boost power conversion circuit, the first AC voltage having a different magnitude than the DC voltage.

10. The method of claim 9, wherein the DC voltage comprises a plurality of DC voltages and the buck-boost power conversion circuit comprises a plurality of DC/AC switched networks electrically coupled in series for converting between the plurality of DC voltages and the second AC voltage.

11. The method of claim 9, wherein the DC voltage comprises a plurality of DC voltages, wherein receiving the plurality of DC voltages comprises receiving the plurality of DC voltages from a plurality of photovoltaic cells and wherein converting the plurality of DC voltages to the second AC voltage comprises using a plurality of DC/AC switched networks electrically coupled in series.

12. The method of claim 9, further comprising:
converting, by the buck-boost power conversion circuit, the DC voltage generated by a photovoltaic cell to the first AC voltage that is electrically coupled to an electrical grid and wherein a first magnitude of the DC voltage is greater than a second magnitude of the first AC voltage.

13. The method of claim 9, wherein the buck-boost power conversion circuit further comprises an inductor that electrically couples the DC/AC switched network and the AC/AC switched network.

14. The method of claim 9, wherein the AC/AC switched network comprises a wide bandgap bidirectional semiconductor for executing an anti-islanding function by deactivating the buck-boost power conversion circuit in response to detecting power outage.

15. The method of claim 9, wherein the DC voltage comprises a plurality of DC voltages each electrically coupled to a separate battery, wherein the DC/AC switched network comprises a plurality of DC/AC switched networks electrically coupled in series for allowing the separate batteries to charge independently.

16. A method comprising:
receiving, by a buck-boost power conversion circuit, a first AC voltage from an AC source electrically coupled to the buck-boost power conversion circuit;
converting, by the buck-boost power conversion circuit, the first AC voltage to a second AC voltage using an AC/AC switched network;
converting, by the buck-boost power conversion circuit, the second AC voltage to a DC voltage using a DC/AC switched network; and
outputting, by the buck-boost power conversion circuit, the DC voltage to a DC load electrically coupled to the buck-boost power conversion circuit, the DC voltage having a different magnitude than the first AC voltage.

17. The method of claim 16, wherein the DC voltage comprises a plurality of DC voltages and wherein converting the second AC voltage to the DC voltage comprises:
converting the second AC voltage to the plurality of DC voltages using a plurality of DC/AC switched networks electrically coupled in series; and
transmitting the plurality of DC voltages by transmitting each of the plurality of DC voltages to a separate battery for charging the separate batteries independently.

18. The method of claim 16, wherein the buck-boost power conversion circuit further comprises an inductor that electrically couples the DC/AC switched network and the AC/AC switched network.

19. The method of claim 16, wherein the AC/AC switched network comprises a wide bandgap bidirectional semiconductor for executing an anti-islanding function by deactivating the buck-boost power conversion circuit in response to detecting power outage.

20. The method of claim 16, wherein the buck-boost power conversion circuit is for converting the second AC voltage from an electrical grid to the DC voltage electrically coupled to a battery for charging the battery.
